(19) United States
(12) Patent Application Publication
(10) Pub. No.: US 2007/0282880 A1
(43) Pub. Date: Dec. 6, 2007

(54) Partial role or task allocation responsive to data-transformative attributes

(75) Inventors: Alexander J. Cohen, Mill Valley, CA (US); Edward K.Y. Jung, Bellevue, WA (US); Royce A. Levien, Lexington, MA (US); Robert W. Lord, Seattle, WA (US); William Henry Mangione-Smith, Kirkland, WA (US); Clarence T. Tegreene, Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/445,503

(22) Filed: May 31, 2006

(51) Int. Cl. G06F 7/00

(52) U.S. Cl. 707/101

(57) ABSTRACT

A method and system are described for selecting a first process responsive to an attribute of the first process and to an indication of a second process serving a data-transformative role or for selecting a first service responsive to an attribute of the first service, to an indication of a second service relating to a task, and to a data-transformative attribute of the task, and for allocating a portion of the task to the first service selected responsive to the attribute of the first service, to the indication of the second service relating to the task, and to the data-transformative attribute of the task or for partially allocating the data-transformative role to the first process selected responsive to the attribute of the first process and to the indication of the second process serving the data-transformative role.

### SUMMARY

An embodiment provides a method. In one implementation, the method includes but is not limited to selecting a first process responsive to an attribute of the first process and to an indication of a second process serving a data-transformative role and partially allocating the data-transformative role to the first process selected responsive to the attribute of the first process and to the indication of the second process serving the data-transformative role. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for selecting a first process responsive to an attribute of the first process and to an indication of a second process serving a data-transformative role and circuitry for partially allocating the data-transformative role to the first process selected responsive to the attribute of the first process and to the indication of the second process serving the data-transformative role. In addition to the foregoing, other system aspects are described in the claims, drawings, and text forming a part of the present disclosure.

An embodiment provides a method. In one implementation, the method includes but is not limited to selecting a first service responsive to an attribute of the first service, to an indication of a second service relating to a task, and to a data-transformative attribute of the task and allocating a portion of the task to the first service selected responsive to the attribute of the first service, to the indication of the second service relating to the task, and to the data-transformative attribute of the task. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for selecting a first service responsive to an attribute of the first service, to an indication of a second service relating to a task, and to a data-transformative attribute of the task and circuitry for allocating a portion of the task to the first service selected responsive to the attribute of the first service, to the indication of the second service relating to the task, and to the data-transformative attribute of the task. In addition to the foregoing, other system aspects are described in the claims, drawings, and text forming a part of the present disclosure.

In addition to the foregoing, various other embodiments are set forth and described in the text (e.g., claims and/or detailed description) and/or drawings of the present description.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 depicts an exemplary environment in which one or more technologies may be implemented.

FIG. 2 depicts a high-level logic flow of an operational process.

FIG. 3 depicts an exemplary environment in which one or more technologies may be implemented.

FIG. 4 depicts another high-level logic flow of an operational process.

FIG. 5 depicts another exemplary environment in which one or more technologies may be implemented.

FIGS. 6-8 depict variants of the flow of FIG. 2.

FIG. 9 depicts variants of the flow of FIG. 4.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

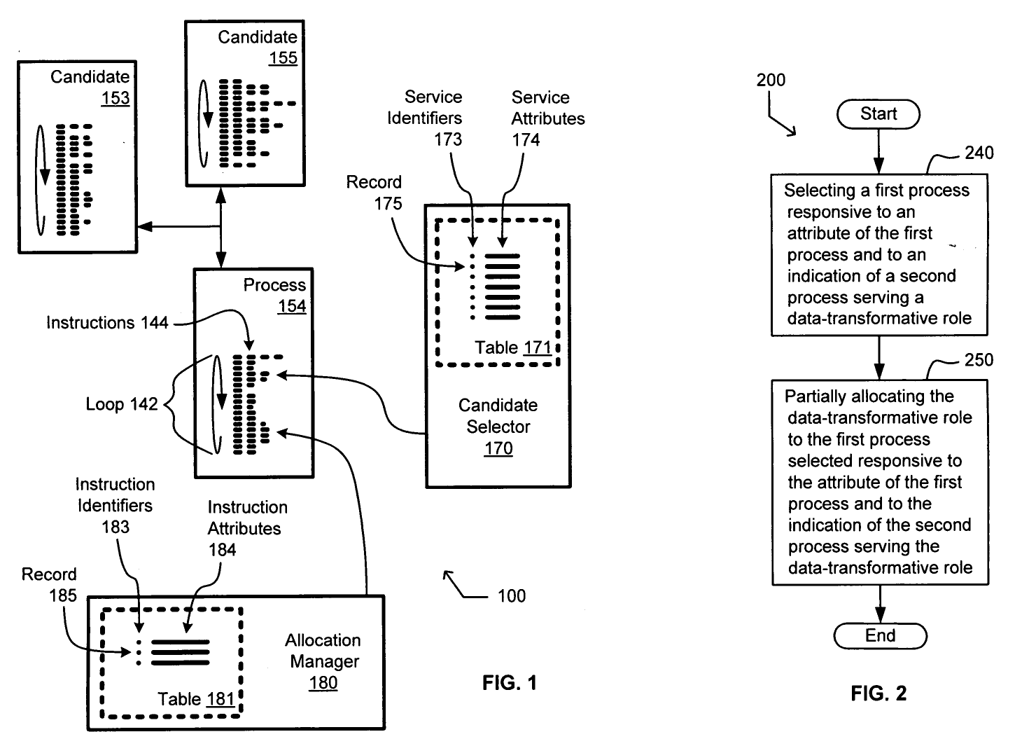

Referring now to FIG. 1, there is shown an exemplary environment in which one or more technologies may be implemented. As shown network subsystem 100 comprises process 154 able to interact with two or more other processes identified as candidate 153 and candidate 155. As shown, candidate 153, process 154, and candidate 155 each comprise an operating system or other iteratively executed program loop 142 comprising instructions 144. At least some of the instructions 144 can foreseeably become burdensome for process 154 to perform alone, so that sharing a role served by instructions 144 may make service of the role faster, more reliable, less costly, more scalable, or otherwise advantageous. Among instructions 144 is candidate selector 170, which includes one or more instructions for selecting candidate 153 or candidate 155, and may include part or all of table 171. Table 171 can associate one or more service identifiers 173 or one or more service attributes 174 by including each grouping in a common record 175. Also among instructions 144 is allocation manager 180, which includes one or more instructions for allocating some of instructions 144 to the selected candidate(s). Allocation manager 180 may include part or all of table 181. Table 181 can associate one or more instruction identifiers 183 or one or more instruction attributes 184 by including each grouping in a common record 185.

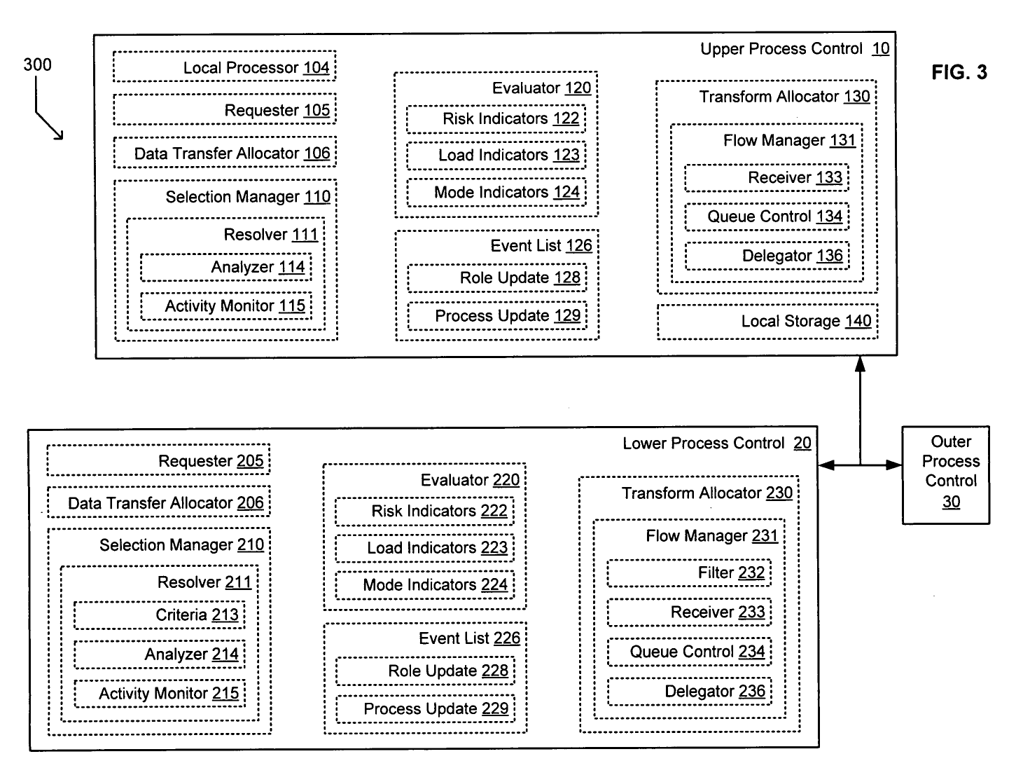

Referring now to FIG. 2, there is shown a high-level logic flow 200 of an operational process. Operation 240 describes selecting a first process responsive to an attribute of the first process and to an indication of a second process serving a data-transformative role (e.g. candidate selector 170 deciding upon candidate 153 based on an indication of an availability or suitability of candidate 153 to share a large computational task or other potentially burdensome role). In some embodiments, for example, the availability or suitability of each candidate can considered in turn until an acceptable one is identified. Alternatively, suitability indicators of two or more candidates can be compared and one or more of the most suitable candidates can be selected in operation 240. Candidate selector 170 can perform operation 240 by considering a data-transformative role that can be served by one or more candidates (e.g. including those of candidate 153, identified by one or more service identifiers 173 and characterized by one or more service attributes 174 of candidate 153, such as a handle of a role it serves).

Operation 250 describes partially allocating the data-transformative role to the first process selected responsive to the attribute of the first process and to the indication of the second process serving the data-transformative role (e.g. allocation manager 180 signaling candidate 153 sharing the “potentially burdensome role” mentioned above). This can be accomplished, for example, by modifying process 154 so that some subset of the defined set of receivable requests or other data will trigger tasks routed via process 154 to (selected) candidate 153. Alternatively or additionally, in some embodiments, process 154 may transmit a request “upstream” (to an external source of requests, e.g., not shown) that such a subset will trigger tasks routed “directly” to candidate 153 (not via process 154).

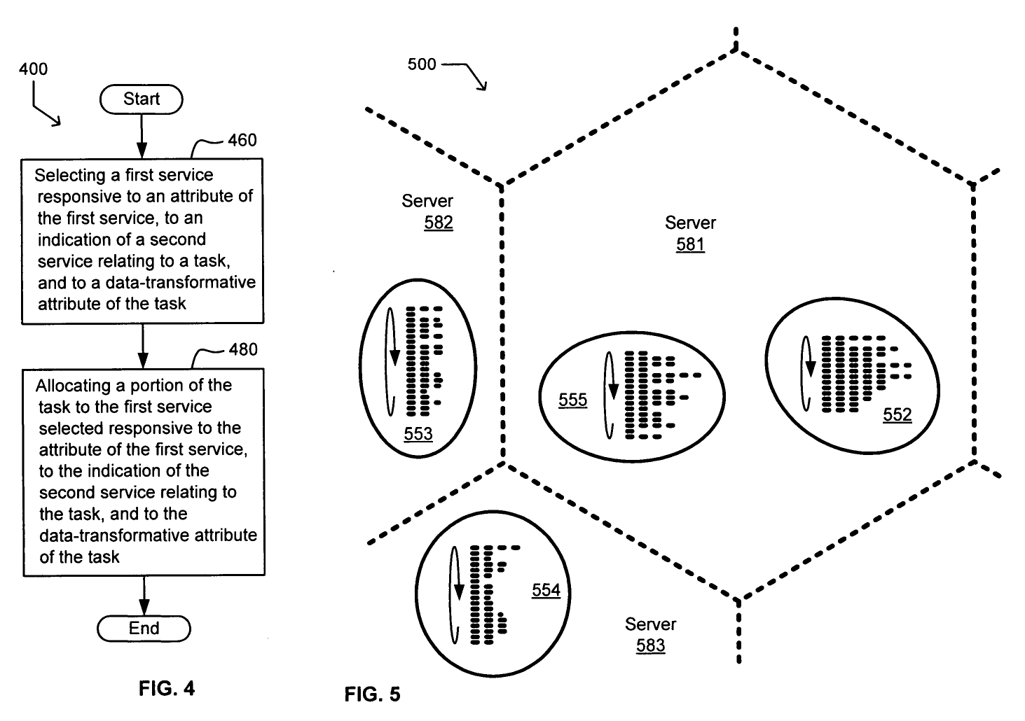

Referring now to FIG. 3, there is shown another exemplary environment in which one or more technologies may be implemented. As shown network subsystem 300 comprises “upper” process control 10, “lower” process control 20, and “outer” process control 30. Those skilled in the art will appreciate that these names are for convenience of review, and that the depicted process controls may be arranged in any fashion within one server or across several mutually remote servers. In some embodiments, “remote” servers are those separated by at least 10 meters of a passive transmission medium or by one or more active relay devices operating between them.

As shown, upper process control 10 can optionally comprise one or more of local processor 104, requester 105, data transfer allocator 106, selection manager 110, evaluator 120, event list 126, transform allocator 130, or local storage 140. Selection manager 110 can optionally include resolver 111 comprising one or more of analyzer 114 or activity monitor 115. Evaluator 120 optionally comprises one or more of each of risk indicators 122, load indicators 123, or mode indicators 124. Event list 126 can optionally include role update 128 or process update 129. Transform allocator 130 can optionally include flow manager 131 comprising one or more of receiver 133, queue control 134, or delegator 136.

Similarly, lower process control 20 can optionally comprise one or more of local requester 205, data transfer allocator 206, selection manager 210, evaluator 220, event list 226, or transform allocator 230. Selection manager 210 can optionally include resolver 211 comprising one or more of analyzer 214, one or more criteria 213, or activity monitor 215. Evaluator 220 optionally comprises one or more of each of risk indicators 222, load indicators 223, or mode indicators 224. Event list 226 can optionally include role update 228 or process update 229. Transform allocator 230 can optionally include flow manager 231 comprising one or more of receiver 233, queue control 234, or delegator 236.

It will be appreciated by those skilled in the art that any or all of lower process control 20 and outer process control 30 can be implemented in logic, instructions on signal-bearing media, or the like, or in some combination of these. The same applies to upper process control 10 except for local processor 104 and local storage 140. Moreover it will be understood that outer process control 30 may contain instances of components like those of upper process control 10, and also that upper process control 10 may include subsets, supersets, and additional instances of the components shown therein. Lower process control 20 may likewise include one or more processors, network interfaces, storage elements, or the like (not shown).

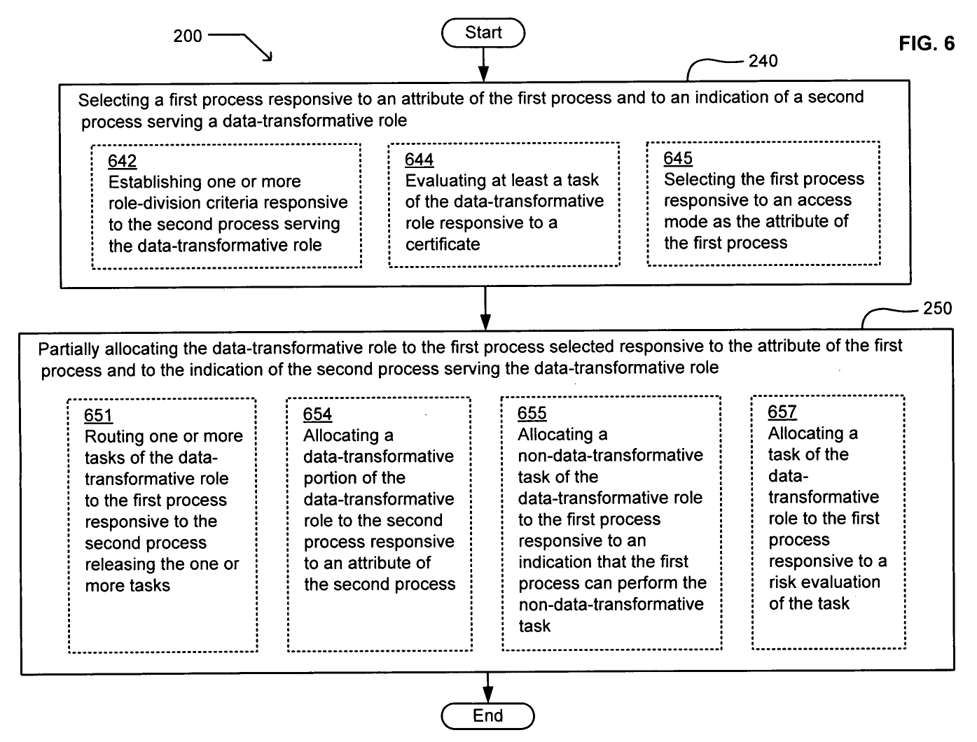

Referring now to FIG. 4, there is shown a high-level logic flow 400 of an operational process. Operation 460 describes selecting a first service responsive to an attribute of the first service, to an indication of a second service relating to a task, and to a data-transformative attribute of the task (e.g. candidate selector 170 selecting candidate 155 responsive at least to a status of candidate 155 being “less than 5% utilized,” to an indication of process 154 associated with a decryption task apparently needing quadrillions of computations). The selection can be a largest one of two or more sums of factors each on a 1-to-10 scale, for example, each sum indicating a candidate. Those skilled in the art will appreciate that many suitable algorithmic variants can readily be generated in light of these teachings, however, without any undue experimentation.

Operation 480 describes allocating a portion of the task to the first service selected responsive to the attribute of the first service, to the indication of the second service relating to the task, and to the data-transformative attribute of the task (e.g. allocation manager 180 allocating record 185 to candidate 155 selected by operation 460 as described above). The allocation can comprise adding an identifier of candidate 155 to record 185, for example, or by transmitting or otherwise transferring part or all of record 185 from process 154 to (selected) candidate 155.

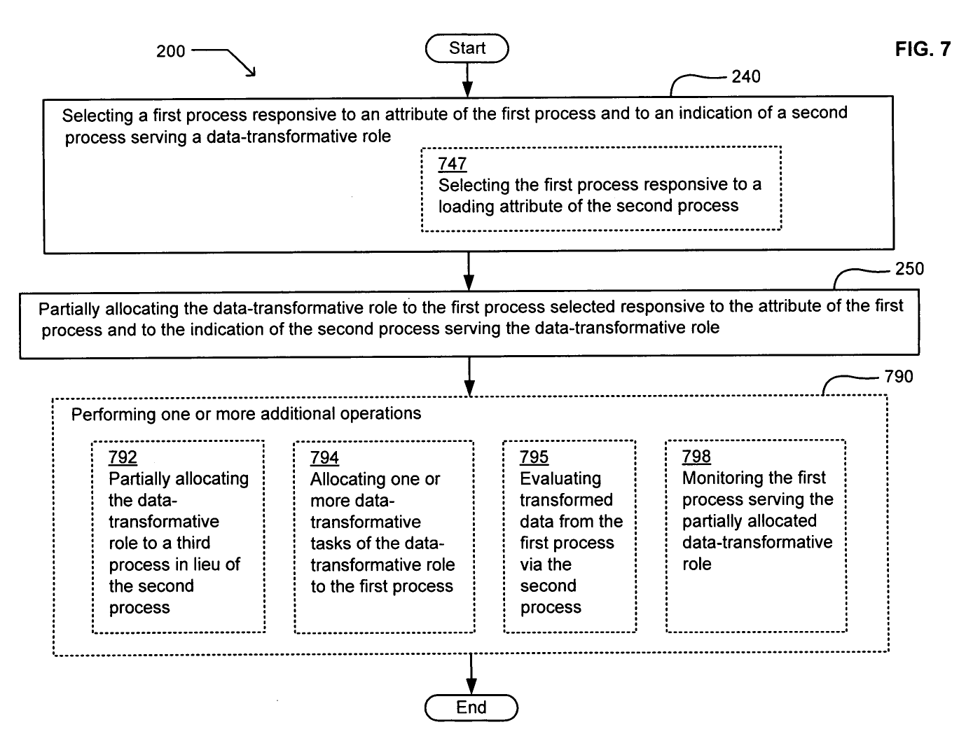

Referring now to FIG. 5, there is shown another exemplary environment in which one or more technologies may be implemented. As shown network subsystem 500 comprises a network including at least server 581, server 582, and server 583, each connected directly (through passive linkages only, e.g.) to each of the others. Moreover these servers contain a substantially mobile network of software agents, as shown including at least agent 552, agent 553, agent 554, and agent 555. These agents are each likewise connected directly to each of the others substantially without entanglements with other software entities such as operating systems of the servers, not shown. Those skilled in the art will appreciate that under these conditions, agent 553 can emulate candidate 153, agent 554 can emulate process 154, and agent 555 can emulate candidate 155 in substantially all of the variants described herein. Those skilled in the art will also appreciate that agent 555 emulate lower process control 10′ in variants described herein, with upper process control 20 and outer process control 30 emulated by agent 552 or agent 553. Other workable combinations will be apparent to those skilled in the art as well, in light of teachings herein.

Referring again to FIG. 4, for example, flow 400 can be implemented to select one or more of agent 552, agent 553, or agent 555 at operation 460. Any of these agents can be configured, in some embodiments, so that at operation 480—allocating a portion of the task to the first service selected responsive to the attribute of the first service, to the indication of the second service relating to the task, and to the data-transformative attribute of the task—a portion of a task relating to agent 554 can be partially allocated to the selected agent(s).

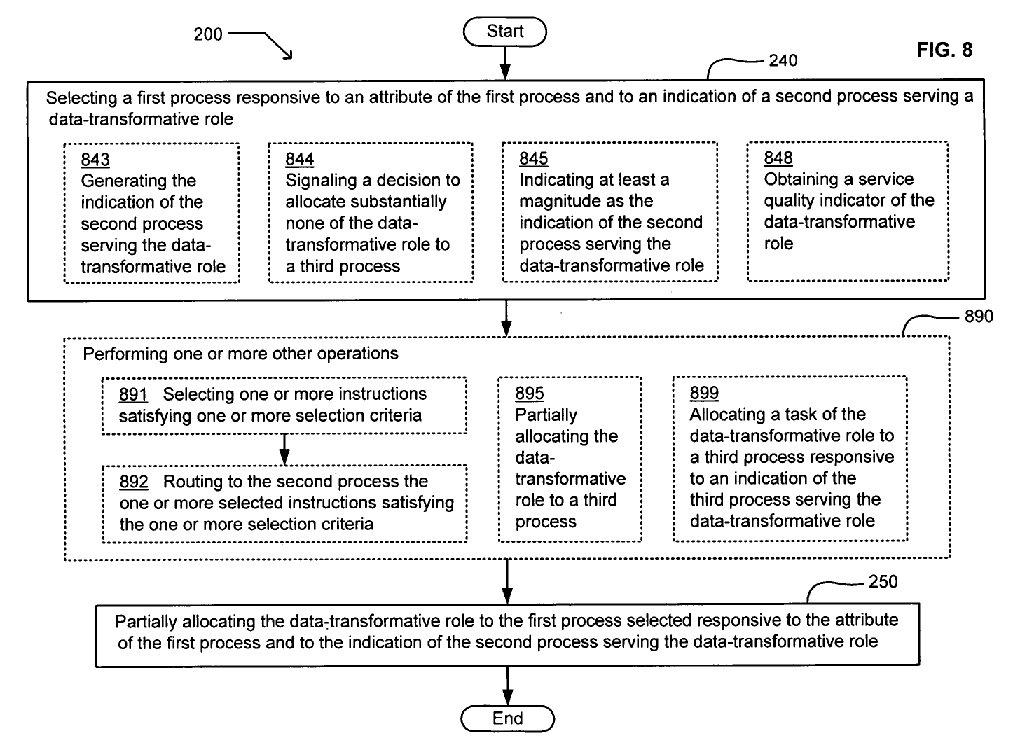

Referring now to FIG. 6, there are shown several variants of the flow 200 of FIG. 2. Operation 240—selecting a first process responsive to an attribute of the first process and to an indication of a second process serving a data-transformative role—may include one or more of the following operations: 642, 644, or 645. Operation 250—partially allocating the data-transformative role to the first process selected responsive to the attribute of the first process and to the indication of the second process serving the data-transformative role—may include one or more of the following operations: 651, 654, 655, or 657.

Operation 642 describes establishing one or more role-division criteria responsive to the second process serving the data-transformative role (e.g. analyzer 114 deciding whether to divide tasks by even/odd field attributes, by alphabetical field attributes, or distributing workload by some other systematic categorization). This can occur, for example, in embodiments in which selection manager 110 performs operation 240, such as by generating or using one or more criteria 213 for process selection, and in which transform allocator 130 performs operation 250. The categorization can be selected and updated to equalize the role's workload between the participating processes, to take advantage of special skills or available capacity of some processes, to minimize a participation of a key process, to minimize overall cost, or the like.

Operation 644 describes evaluating at least a task of the data-transformative role responsive to a certificate (e.g. evaluator 120 generating or utilizing one or more risk indicators 122 that indicate whether the task, task grouping, or task source are trustworthy). This can occur, for example, in embodiments in which selection manager 110 performs operation 240 and in which transform allocator 130 performs operation 250. The one or more risk indicators 122 can include a trust indicator or the like received directly from evaluator 220, for example.

Operation 645 describes selecting the first process responsive to an access mode as the attribute of the first process (e.g. resolver 111 and evaluator 120 jointly generating or utilizing an indication that upper process control 10 can access a remote data source). This can be an important consideration, for example, in situations where another candidate process cannot quickly or easily access an important resource.

Operation 651 describes routing one or more tasks of the data-transformative role to the first process responsive to the second process releasing the one or more tasks (e.g. queue control 134 accepting and beginning image processing operations responsive to the original process authorizing that division of labor). This can occur, for example, in embodiments in which selection manager 110 performs operation 240, in which requestor 105 asks for the release from lower process control 20, and in which transform allocator 130 performs operation 250.

Operation 654 describes allocating a data-transformative portion of the data-transformative role to the second process responsive to an attribute of the second process (e.g. delegator 136 recording, requesting, or otherwise indicating that lower process control 20 perform an upcoming decompilation task responsive to an indication that lower process control is capable of performing decompilation). This can occur, for example, in embodiments in which selection manager 110 performs operation 240 and in which transform allocator 130 performs operation 250. In various embodiments, delegator 136 may take this action responsive also to flow manager 131 recognizing decompilation as a task attribute incompatible with queue control 134. Alternatively or additionally, delegator 136 may take this action responsive also to one or more load indicators 123 indicating surplus capacity within lower process control 20.

Operation 655 describes allocating a non-data-transformative task of the data-transformative role to the first process responsive to an indication that the first process can perform the non-data-transformative task (e.g. data transfer allocator 106 generating a copy of a remote database in local storage 140 for use in performing the data-transformative role). Alternatively or additionally, the non-data-transformative task may include making or locating additional data sources or copies of data sources. Alternatively or additionally, the non-data-transformative task may include spawning or locating more processes able to share the data-transformative role. In some embodiments, data transfer allocator 106 may take actions like these automatically responsive to an indication that a data source is heavily utilized, at risk, rarely changing, or the like.

Operation 657 describes allocating a task of the data-transformative role to the first process responsive to a risk evaluation of the task (e.g. queue control 134 rejecting write operations but accepting all other operations from receiver 133). This can occur, for example, in embodiments in which selection manager 110 performs operation 240, in which evaluator 120 uses one or more risk indicators 122 to decide that the write operations are high risk, and in which transform allocator 130 performs operation 250. Evaluator 120 can thus implement an intermediate security policy, for example, that is local to upper process control 10. In some embodiments, evaluator 120 can cause queue control 134 to accept all operations from receiver 133, for example, with a more risk-tolerant local security policy. Alternatively or additionally, evaluator 120 can implement any of a diverse array of security configurations known to those skilled in the art.

Referring now to FIG. 7, there are shown several variants of the flow 200 of FIG. 2 or FIG. 6. Operation 240—selecting a first process responsive to an attribute of the first process and to an indication of a second process serving a data-transformative role—may optionally include operation 747.

Operation 747 describes selecting the first process responsive to a loading attribute of the second process (e.g. resolver 211 signaling that upper process control 10 can more easily share the data-transformative role than outer process control 30 based on one or more load indicators 223). This can occur, for example, in embodiments in which selection manager 210 performs operation 240, in which load indicators 223 reflect recent status information from or about upper process control 10 at least, and in which transform allocator 230 performs operation 250.

Flow 200 may further include operation 790, which describes performing one or more additional operations (e.g. various portions of lower process control 20 collecting or providing capability or performance data to facilitate effective role or task sharing). In some embodiments, for example, requester 205 can broadcast a request (a) for an update from participating processes or (b) for an identification of other processes that become available. Operation 790 may optionally include one or more of the following operations: 792, 794, 795, or 798.

Operation 792 describes partially allocating the data-transformative role to a third process in lieu of the second process (e.g. data transfer allocator 206 and requester 205 jointly signaling that outer process control 30 will share the data-transformative role with upper process control 10). In some embodiments, transform allocator 230 completes the allocation responsive to an acceptance signal from outer process control 30. Alternatively or additionally, outer process control 30 can provide such an acceptance before operation 240 so that transform allocator 230 or data transfer allocator 206 can complete operation 792 without further information from outer process control 30.

Operation 794 describes allocating one or more data-transformative tasks of the data-transformative role to the first process (e.g. delegator 236 transmitting one or more instructions of an encryption task to upper process control 10). This can occur, for example, in embodiments in which selection manager 210 performs operation 240, in which transform allocator 230 performs operation 250, and in which delegator 236 and evaluator 220 jointly implement an adaptive role-sharing scheme. The scheme can be updated, for example, responsive to an overflow indication or the like from upper process control 10. It will be understood that operation 794 can optionally overlap operation 250 temporally. Those skilled in the art will appreciate that the sequencing of these operations, and many others herein, are not critical to their success.

Operation 795 describes evaluating transformed data from the first process via the second process (e.g. evaluator 220 duplicating some delegated tasks to determine whether work product from the first process indicates that the first process should be trusted). Such a verification can be performed periodically, randomly, or otherwise on an aggregate or other representative basis, for example, and used for ensuring that iteratively generated risk indicators 222 describing the first process remain below a given maximum. Those skilled in the art will appreciate that the risk indicators 222 can comprise a bit error rate, a success rate, or the like.

Operation 798 describes monitoring the first process serving the partially allocated data-transformative role (e.g. receiver 233 distilling and recording some data from or about the first process periodically as process update 229). The data may include work product, requests for more work, a heartbeat, or the like. Alternatively or additionally, evaluator 220 can monitor the first process by observing state changes in a shared resource (e.g. local storage 140). In some embodiments, the monitoring can likewise be used for generating or updating one or more risk indicators 222, one or more load indicators 223, or one or more mode indicators 224.

Referring now to FIG. 8, there are shown several variants of the flow 200 of FIG. 2, FIG. 6, or FIG. 7. Operation 240—selecting a first process responsive to an attribute of the first process and to an indication of a second process serving a data-transformative role-may include one or more of the following operations: 843, 844, 845, or 848.

Operation 843 describes generating the indication of the second process serving the data-transformative role (e.g. activity monitor 215 indicating that responding to gene sequencing processing requests arriving via a website server has recently become a demanding role). This can occur, for example, in embodiments in which selection manager 210 performs operation 240, in which transform allocator 230 performs operation 250, and in which activity monitor 215 and evaluator 220 jointly recognize a potential opportunity for sharing the request processing role. For example, evaluator 220 can respond to data from activity monitor 215 by increasing one or more of load indicators 223 relating to lower process control 20. Alternatively or additionally, a basic indication of the second process serving the data-transformative role can be received in event list 226 when the second process is initially assigned that role.

Operation 844 describes signaling a decision to allocate substantially none of the data-transformative role to a third process (e.g. process update 229 indicating that outer process control 30 is offline indefinitely). Alternatively or additionally, analyzer 214 can be configured to evaluate a compatibility between a seismic modeling role and the third process. Those skilled in the art will appreciate that some processes are better suited to seismic modeling than others, and that the degree of fit can be indicated by a ranking of the process among several, a predicted or averaged number of instructions per second, or the like.

Operation 845 describes indicating at least a magnitude as the indication of the second process serving the data-transformative role (e.g. load indicators 223 including a processing load as a percentile, an amount of free space in megabytes, an amount of time until completion, a number of jobs pending, or the like). This can occur, for example, in embodiments in which selection manager 210 performs operation 240 and in which transform allocator 230 performs operation 250. This can likewise occur in embodiments in which operation 240 is jointly performed by selection manager 110 and selection manager 210. Alternatively or additionally the indication of the second process serving the data-transformative role can include one or more state changes of event list 126 or event list 226, for example.

Operation 848 describes obtaining a service quality indicator of the data-transformative role (e.g. role update 228 recording a mean time to completion across several tasks, a mean task success rate across the entire role, or a cumulative downtime of one or more participating processes, resources, or other services). Alternatively or additionally, a user or other client may provide one or more service quality criteria of the data-transformative role. In some embodiments, each of the scalar service quality indicators can thus be compared occasionally against each pertinent requirement to ascertain whether a specification for the role was met.

Flow 200 may likewise include operation 890, which describes performing one or more other operations (e.g. data transfer allocator 206 or transform allocator 230 allocating portions of the role to a third process). The other operations can, in some embodiments, be performed integrally or otherwise overlappingly with operation 250 or its variants, for example, in FIG. 6. Operation 890 may optionally include one or more of the following operations: 891, 892, 895, or 899.

Operation 891 describes selecting one or more instructions satisfying one or more selection criteria (e.g. filter 232 identifying unauthorized read instructions, self-modifying code, instructions from an unknown source, or the like for delegation to a higher-security process). This can occur, for example, in embodiments in which selection manager 210 performs operation 240 and in which transform allocator 230 performs operation 250. Alternatively or additionally, evaluator 220 can be configured to assign one or more risk indicators 222 to a subroutine as a scalar risk indicator of a riskiest instruction found in the subroutine. Optionally filter 232 can thus apply one or more criteria to the subroutine's risk indicators for selecting one or more of operations having a nominal-range, higher-than-nominal, or lower-than-nominal risk. Those skilled in the art will appreciate that operation 891 can readily implement a wide variety of individual and collective instruction selection criteria within the scope and spirit of these teachings.

Operation 892 describes routing to the second process the one or more selected instructions satisfying the one or more selection criteria (e.g. flow manager 231 causing queue control 234 to accept only commands in lower-than-nominal risk subroutines, responsive to an indication that lower process control 20 governs a critical process, or a process in a critical server). Alternatively or additionally, additional instances of operations 891 and 892 can be configured cooperatively, such as by having respectively complementary selection criteria governing flow manager 131 and queue control 134. This can occur, for example, in an embodiment in which transform allocator 130 and transform allocator 230 cooperatively perform or each instantiate operation 250, for example.

Operation 895 describes partially allocating the data-transformative role to a third process (e.g. queue control 234 accepting a portion of a role previously shared only by upper process control 10 and lower process control 20). This can occur, for example, in embodiments in which lower process control 20 partly transfers a role from outer process control 30 to upper process control and also transfers at least some of the role to itself. Alternatively or additionally, this can occur in embodiments in which a complete or partial role transfer from upper process control 10 to outer process control 30 has occurred, and in which queue control 234 accepts one or more tasks of that role from the recipient (e.g. as a sub-delegation from outer process control 30).

Operation 899 describes allocating a task of the data-transformative role to a third process responsive to an indication of the third process serving the data-transformative role (e.g. flow manager 131 and process update 129 responding to an incoming data transfer or processing request by assigning the request to queue control 134). This can occur, for example, in embodiments in which lower process control 20 controls the “first” process, in which outer process control 30 controls the “second” process, and in which the role is initially shared among several processes.

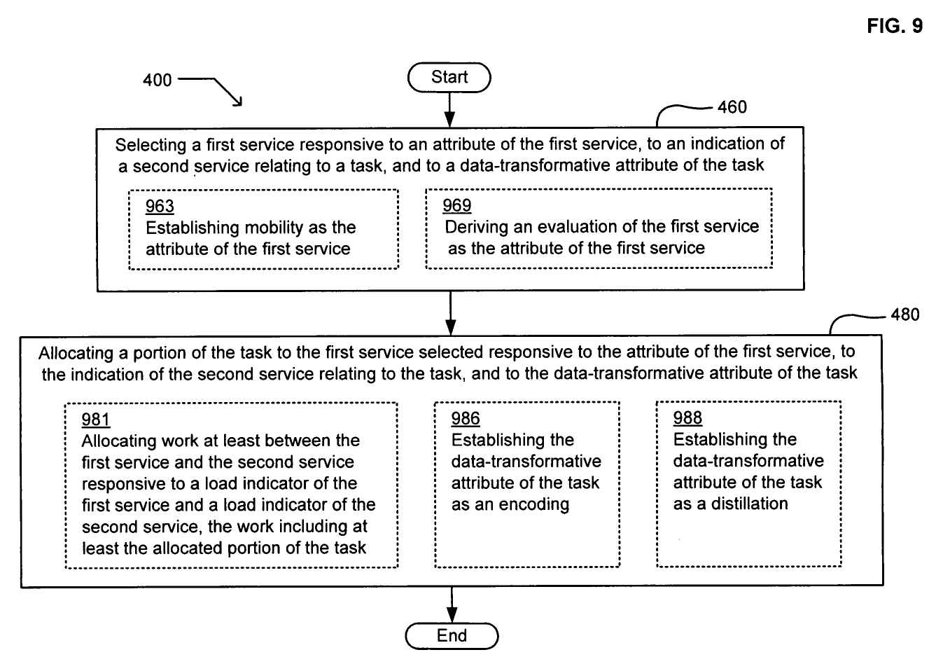

Referring now to FIG. 9, there are shown several variants of the flow 400 of FIG. 4. Operation 460—selecting a first service responsive to an attribute of the first service, to an indication of a second service relating to a task, and to a data-transformative attribute of the task—may include one or more of operation 963 or operation 969. Operation 480—allocating a portion of the task to the first service selected responsive to the attribute of the first service, to the indication of the second service relating to the task, and to the data-transformative attribute of the task—optionally including one or more of the following operations: 981, 986, or 988.

Operation 963 describes establishing mobility as the attribute of the first service (e.g. selection manager 110 selecting outer process control 30 responsive to an indication that outer process control 30 controls a mobile program). This can occur, for example, in embodiments in which selection manager 110 performs operation 460, in which the “outer” process is the selected “first” service, and in which transform allocator 130 performs operation 480. Alternatively or additionally, at operation 460, the selection can also be based on other attributes describing outer process control 30 such as risk indicators 122, load indicators 123, or mode indicators 124.

Operation 969 describes deriving an evaluation of the first service as the attribute of the first service (e.g. evaluator 120 adjusting risk indicators 122 from observations of unstable behavior or load indicators 123 by observing processor usage). This can occur, for example, in embodiments in which selection manager 110 and evaluator 120 jointly perform operation 460 and in which transform allocator 130 or data transfer allocator 106 perform operation 480. Alternatively or additionally, operation 460 can be performed jointly across processes, such as by selection manager 110 and one or more components of evaluator 220.

Operation 981 describes allocating work at least between the first service and the second service responsive to a load indicator of the first service and a load indicator of the second service, the work including at least the allocated portion of the task (e.g. flow manager 131 balancing a processing load among upper process control 10, lower process control 20, and outer process control 30). This can occur, for example, in embodiments in which selection manager 110 performs operation 460 and in which at least transform allocator 130 performs operation 480. Alternatively or additionally, an estimated completion time for each allocated work segment can be used as a load indicator and updated as the segment progresses. These estimates and updates can be recorded as process updates 129 in some embodiments.

Operation 986 describes establishing the data-transformative attribute of the task as an encoding (e.g. evaluator 120 characterizing the task as one or more of encrypting, compiling, compressing, multiplexing or the like responsive to observing local processor 104 and queue control 134 at least beginning the task). In some embodiments the data-transformative attribute(s) comprise risk indicators 122 or load indicators 123, for example.

Operation 988 describes establishing the data-transformative attribute of the task as a distillation (e.g. evaluator 120 recognizing “total” or “summary” in a report at least partly generated by the task). Alternatively or additionally, this attribute can be established based on a self-categorization by a program code segment for performing the task, or by a prevalence of logical or arithmetic combination operations within the program code segment. Alternatively or additionally, the task can be categorized as an aggregation, for example, responsive to program code implementing or self-identification as indexing, annotating, or otherwise transforming data for better accessibility).

Alternatively or additionally, one or more variants of operation 240 shown in FIGS. 6-8 can further shape these variants of operation 460, such as by recognizing a “first process” of operation 240 as a “first service” of operation 460. In some embodiments these hybrid flows incorporate optional features (such as operations 843, 844, 845, and 848, e.g.) other than operation 240 itself. One or more variants of operation 250, 790, or 890 shown above can likewise further shape operation 480, such as by recognizing a partially-allocated role of operation 250 as task apportioned by operation 460. In some embodiments these hybrid flows do not incorporate operation 250 per se, however.

It will be understood that variations in business models relating to the technologies described herein may prove advantageous, for example in situations in which an information systems consultant or other service provider acts for the benefit of one or more clients or interests to achieve such technologies collectively. Such arrangements can facilitate organizational or tool specialization and cost effectiveness, for example, across distributed networks in the global marketplace. Those skilled in the art will recognize that such beneficial interaction creates a commercial web constituting a single defacto entity of two or more interacting participants cooperatively implementing the teachings herein, within the scope and spirit of the claimed invention.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly.

1. A method comprising:
selecting a first process responsive to an attribute of the first process and to an indication of a second process serving a data-transformative role; and
partially allocating the data-transformative role to the first process selected responsive to the attribute of the first process and to the indication of the second process serving the data-transformative role.

2. The method of claim 1 in which selecting a first process responsive to an attribute of the first process and to an indication of a second process serving a data-transformative role comprises:
establishing one or more role-division criteria responsive to the second process serving the data-transformative role.

3. (canceled)

4. The method of claim 1 in which selecting a first process responsive to an attribute of the first process and to an indication of a second process serving a data-transformative role comprises:
selecting the first process responsive to an access mode as the attribute of the first process.

5-6. (canceled)

7. The method of claim 1 in which partially allocating the data-transformative role to the first process selected responsive to the attribute of the first process and to the indication of the second process serving the data-transformative role comprises:
allocating a non-data-transformative task of the data-transformative role to the first process responsive to an indication that the first process can perform the non-data-transformative task.

8. (canceled)

9. The method of claim 1 in which selecting a first process responsive to an attribute of the first process and to an indication of a second process serving a data-transformative role comprises:
selecting the first process responsive to a loading attribute of the second process.

10-12. (canceled)

13. The method of claim 1 further comprising:
evaluating transformed data from the first process via the second process.

14. The method of claim 1 further comprising:
monitoring the first process serving the partially allocated data-transformative role.

15. The method of claim 1 in which selecting a first process responsive to an attribute of the first process and to an indication of a second process serving a data-transformative role comprises:
generating the indication of the second process serving the data-transformative role.

16. The method of claim 1 in which selecting a first process responsive to an attribute of the first process and to an indication of a second process serving a data-transformative role comprises:
signaling a decision to allocate substantially none of the data-transformative role to a third process.

17. (canceled)

18. The method of claim 1 in which selecting a first process responsive to an attribute of the first process and to an indication of a second process serving a data-transformative role comprises:
obtaining a service quality indicator of the data-transformative role.

19. (canceled)

20. The method of claim 1 further comprising:
selecting one or more instructions satisfying one or more selection criteria; and
routing to the second process the one or more selected instructions satisfying the one or more selection criteria.

21. (canceled)

22. The method of claim 1 further comprising:
partially allocating the data-transformative role to a third process.

23. (canceled)

24. A system comprising:
means for selecting a first process responsive to an attribute of the first process and to an indication of a second process serving a data-transformative role; and
means for partially allocating the data-transformative role to the first process selected responsive to the attribute of the first process and to the indication of the second process serving the data-transformative role.

25. The system of claim 24 in which the means for selecting a first process responsive to an attribute of the first process and to an indication of a second process serving a data-transformative role comprises:
means for establishing one or more role-division criteria responsive to the second process serving the data-transformative role.

26. The system of claim 24 in which the means for selecting a first process responsive to an attribute of the first process and to an indication of a second process serving a data-transformative role comprises:
means for evaluating at least a task of the data-transformative role responsive to a certificate.

27. The system of claim 24 in which the means for selecting a first process responsive to an attribute of the first process and to an indication of a second process serving a data-transformative role comprises:
means for selecting the first process responsive to an access mode as the attribute of the first process.

28. (canceled)

29. The system of claim 24 in which the means for partially allocating the data-transformative role to the first process selected responsive to the attribute of the first process and to the indication of the second process serving the data-transformative role comprises:
means for allocating a data-transformative portion of the data-transformative role to the second process responsive to an attribute of the second process.

30. (canceled)

31. The system of claim 24 in which the means for partially allocating the data-transformative role to the first process selected responsive to the attribute of the first process and to the indication of the second process serving the data-transformative role comprises:
means for allocating a task of the data-transformative role to the first process responsive to a risk evaluation of the task.

32. The system of claim 24 in which the means for selecting a first process responsive to an attribute of the first process and to an indication of a second process serving a data-transformative role comprises:
means for selecting the first process responsive to a loading attribute of the second process.

33-34. (canceled)

35. The system of claim 24 further comprising:
means for allocating one or more data-transformative tasks of the data-transformative role to the first process.

36-38. (canceled)

39. The system of claim 24 in which the means for selecting a first process responsive to an attribute of the first process and to an indication of a second process serving a data-transformative role comprises:
means for signaling a decision to allocate substantially none of the data-transformative role to a third process.

40. The system of claim 24 in which the means for selecting a first process responsive to an attribute of the first process and to an indication of a second process serving a data-transformative role comprises:
means for indicating at least a magnitude as the indication of the second process serving the data-transformative role.

41. The system of claim 24 in which the means for selecting a first process responsive to an attribute of the first process and to an indication of a second process serving a data-transformative role comprises:
means for obtaining a service quality indicator of the data-transformative role.

42-44. (canceled)

45. The system of claim 24 further comprising:
means for partially allocating the data-transformative role to a third process.

46. The system of claim 24 further comprising:
means for allocating a task of the data-transformative role to a third process responsive to an indication of the third process serving the data-transformative role.

47. A system comprising:
circuitry for selecting a first process responsive to an attribute of the first process and to an indication of a second process serving a data-transformative role; and
circuitry for partially allocating the data-transformative role to the first process selected responsive to the attribute of the first process and to the indication of the second process serving the data-transformative role.

48. (canceled)

49. The system of claim 47 in which the circuitry for selecting a first process responsive to an attribute of the first process and to an indication of a second process serving a data-transformative role comprises:
circuitry for evaluating at least a task of the data-transformative role responsive to a certificate.

50. (canceled)

51. The system of claim 47 in which the circuitry for partially allocating the data-transformative role to the first process selected responsive to the attribute of the first process and to the indication of the second process serving the data-transformative role comprises:
circuitry for routing one or more tasks of the data-transformative role to the first process responsive to the second process releasing the one or more tasks.

52. The system of claim 47 in which the circuitry for partially allocating the data-transformative role to the first process selected responsive to the attribute of the first process and to the indication of the second process serving the data-transformative role comprises:
circuitry for allocating a data-transformative portion of the data-transformative role to the second process responsive to an attribute of the second process.

53-56. (canceled)

57. The system of claim 47 further comprising:
circuitry for partially allocating the data-transformative role to a third process in lieu of the second process.

58. The system of claim 47 further comprising:
circuitry for allocating one or more data-transformative tasks of the data-transformative role to the first process.

59-60. (canceled)

61. The system of claim 47 in which the circuitry for selecting a first process responsive to an attribute of the first process and to an indication of a second process serving a data-transformative role comprises:
circuitry for generating the indication of the second process serving the data-transformative role.

62. (canceled)

63. The system of claim 47 in which the circuitry for selecting a first process responsive to an attribute of the first process and to an indication of a second process serving a data-transformative role comprises:
circuitry for indicating at least a magnitude as the indication of the second process serving the data-transformative role.

64-68. (canceled)

69. The system of claim 47 further comprising:
circuitry for allocating a task of the data-transformative role to a third process responsive to an indication of the third process serving the data-transformative role.

70. A method comprising:
selecting a first service responsive to an attribute of the first service, to an indication of a second service relating to a task, and to a data-transformative attribute of the task; and
allocating a portion of the task to the first service selected responsive to the attribute of the first service, to the indication of the second service relating to the task, and to the data-transformative attribute of the task.

71. The method of claim 70 in which selecting a first service responsive to an attribute of the first service, to an indication of a second service relating to a task, and to a data-transformative attribute of the task comprises:
establishing mobility as the attribute of the first service.

72. (canceled)

73. The method of claim 70 in which allocating a portion of the task to the first service selected responsive to the attribute of the first service, to the indication of the second service relating to the task, and to the data-transformative attribute of the task comprises:
allocating work at least between the first service and the second service responsive to a load indicator of the first service and a load indicator of the second service, the work including at least the allocated portion of the task.

74. The method of claim 70 in which allocating a portion of the task to the first service selected responsive to the attribute of the first service, to the indication of the second service relating to the task, and to the data-transformative attribute of the task comprises:
establishing the data-transformative attribute of the task as an encoding.

75. (canceled)

76. A system comprising:
means for selecting a first service responsive to an attribute of the first service, to an indication of a second service relating to a task, and to a data-transformative attribute of the task; and
means for allocating a portion of the task to the first service selected responsive to the attribute of the first service, to the indication of the second service relating to the task, and to the data-transformative attribute of the task.

77. (canceled)

78. The system of claim 76 in which the means for selecting a first service responsive to an attribute of the first service, to an indication of a second service relating to a task, and to a data-transformative attribute of the task comprises:
means for deriving an evaluation of the first service as the attribute of the first service.

79-80. (canceled)

81. The system of claim 76 in which the means for allocating a portion of the task to the first service selected responsive to the attribute of the first service, to the indication of the second service relating to the task, and to the data-transformative attribute of the task comprises:
means for establishing the data-transformative attribute of the task as a distillation.

82. A system comprising:
circuitry for selecting a first service responsive to an attribute of the first service, to an indication of a second service relating to a task, and to a data-transformative attribute of the task; and
circuitry for allocating a portion of the task to the first service selected responsive to the attribute of the first service, to the indication of the second service relating to the task, and to the data-transformative attribute of the task.

83. The system of claim 82 in which the circuitry for selecting a first service responsive to an attribute of the first service, to an indication of a second service relating to a task, and to a data-transformative attribute of the task comprises:
circuitry for establishing mobility as the attribute of the first service.

84-86. (canceled)

87. The system of claim 82 in which the circuitry for allocating a portion of the task to the first service selected responsive to the attribute of the first service, to the indication of the second service relating to the task, and to the data-transformative attribute of the task comprises:
circuitry for establishing the data-transformative attribute of the task as a distillation.
